(19) United States
(12) Patent Application Publication
(10) Pub. No.: US 2004/0105445 A1
(43) Pub. Date: Jun. 3, 2004

(54) Internet protocol for resource-constrained devices

(76) Inventors: Jeremy Wyn-Harris, Waipukuarau (NZ); Stephen Arthur Hooker, Te Awamutu (NZ)

Correspondence Address: DANIELS DANIELS & VERDONIK, P.A., SUITE 200 GENERATION PLAZA, 1822 N.C. HIGHWAY 54 EAST, DURHAM, NC, 27713, US

(21) Appl. No.: 10/463,551

(22) Filed: Jun. 18, 2003

Related U.S. Application Data
(60) Provisional application No. 60/390,154, filed on Jun. 21, 2002.
(60) Provisional application No. 60/389,666, filed on Jun. 19, 2002.
(60) Provisional application No. 60/390,087, filed on Jun. 21, 2002.

(51) Int. Cl. H04L 12/28; H04L 12/56

(52) U.S. Cl. 370/395.21

(57) ABSTRACT

A method is disclosed for connecting a resource-constrained computer device such as a telephone, camera, or personal digital assistant, to a computer network such that the device can make several simultaneous requests to several communications-connected servers. The method allows for the number of requests to exceed the number of physical connection ports available to the device. Allowance is made for failed and cancelled requests, as well as a priority selection from a number of queued requests.

### FIELD OF THE INVENTION

This invention relates generally to communication in a computer network, and specifically to communication in an Internet network to and from a resource constrained device.

### BACKGROUND

The contents of the Applicant's prior provisional applications, on which priority is claimed, are incorporated by reference. These are Internet camera controlled via an Internet Portal (60/390,154 filed Jun. 21, 2002); Connection Requests Buffering in TCP (60/389,666 filed Jun. 19, 2002): and Motion Detection Algorithm Using Gradient Information to Detect Edge Movement (60/390,087 filed Jun. 21, 2002).

The use of the Internet for transmitting information is widespread. Historically, the Internet has been used for communication between computer systems of diverse characteristics. Recently, Internet capability has been added to non-computer devices such as cameras, Personal Digital Assistants (PDAs), and even household appliances such as televisions and refrigerators. These communications use a defined set of interchange commands or protocols which govern the conversations between devices. These new devices are often resource-constrained. That is, in order to maintain the device's size or cost, a limited amount of computer processor power or memory is available, and oftentimes no external storage (optical or magnetic disk, for example) is available. These devices have telecommunication ports (TCPs), which are the means for connecting to external servers. The number of TCPs in a device is a fixed number, depending on the hardware available in the device itself.

Although resource-constrained, these devices are generally equipped to provide more than one simultaneous service to the user. For example, an internet-connected telephone may simultaneously download program updates, still or motion picture images, updates to address book entries, and display Internet web pages. Each of these various services is provided by a connection from the telephone to an appropriate server through one of the TCPs with which data is exchanged to fulfil the user's requested operations. Thus the number of TCPs limits the number of simultaneous service requests possible.

There are several protocols in use, for example, SMTP (Simple Mail Transfer Protocol), FTP (File Transfer Protocol) and HTTP (Hyper Text Transfer Protocol), which serve different purposes and are used by different devices. These protocols form an application layer on top of a global protocol, TCP/IP Using TCP/IP, a connection is made between the device (client) and another computer (server). This connection is made using commands within the TCP/IP protocol, specifically, an “open” request from the device TCP to the server. Having initiated the “open” command, the device TCP then waits for the response saying that the connection has been made. Typically, sufficient TCP and server resources are available to allow the connection to be established and hence provide server access. If insufficient resources are available, either by exceeding the number of simultaneous TCPs or some other constraint, when a connection request is received, then the TCP or server will notify the client that the connection cannot be established, specifically, by sending a “connection reset” to the client. A “connection reset” is then processed by the client device as an error, and an appropriate message is generated and displayed. Typically, the user will then need to manually re-request the action. The time between the “open” request by the TCP and the successful connection of client to server may be on the order of several or even many seconds. During that time, no data is transferred between client and server, and the resources of the request cannot be released. Once the connection is successful, data can be transferred, and once the connection is reset, the TCP is busy until the server is no longer required and the connection is closed. Once connected, other resources can be freed and made available to another request.

Many resource-constrained devices will attempt to connect to several servers at once, either to provide various services to the device, or broadcasting connections request in order to take to first or best suited successful connection. In current art, this strategy is limited by the resources available. In most cases, the limiting resource is the number of TCPs available. Once this number is reached, subsequent requests are failed until an active connection is closed and the TCP becomes available.

What is needed is a connection protocol and device technique which will dramatically expand the number of simultaneous connection requests that can be made by a device without also dramatically increasing the amount of resource available.

It is therefore an object of the present invention to allow a resource-constrained device to make an expanded number of simultaneous connection requests in an Internet network. It is another object of the present invention to allow a number of requests to be made which exceeds the resources available where excess requests are queued and processed in order when resources become available.

### SUMMARY OF THE INVENTION

A technique is disclosed where a resource constrained device in an Internet network makes connection requests to various servers via telecommunications ports. These servers may provide different services, for example, mail, web pages, files, program updates, or other information. Or the servers may provide the same service where the first or best successful connection is used and the others released.

The process of the invention will buffer connection requests. When a request that a new connection be opened is received, but all available connections (TCPs) are in use, then the details of the received connection request (pending request) is stored. When resources become available, the list of pending connections is examined and if the list is not empty, the oldest pending connection request is assigned to the available resource and processed.

### BRIEF DESCRIPTION OF THE DRAWINGS

FIG. 1 illustrates the flow buffering process of the present invention.

FIG. 2 illustrates the logic diagram for the present invention.

### DETAILED DESCRIPTION

A computer system is connected to the Internet through a communications connection. Such a system typically consists of a computer processor, input devices (keyboard, mouse, etc.), a display monitor, output devices (printers, etc.), communications connections, and magnetic or optical storage devices. Such a computer system is connected to the Internet by the communications connection, communicates with other Internet-connect computers and devices through a variety of protocols, for example, File Transfer Protocol (FTP), Simple Mail Transfer Protocol (SMTP) including Post Office Protocol (POP), and Hyper Text Transfer Protocol (HTTP). Programs using these protocols are widespread and many have user interfaces which are simple and easy to learn even for people with no computer skill or experience, and include file transfer programs, Internet browsers, and electronic mail (e-mail) “clients” for sending, receiving, and displaying messages between Internet users.

Current art includes many non-computer devices which connect to the Internet using one or more of these protocols, specifically, telephones, PDAs, televisions, and even refrigerators, to name just a few. These devices connect to one or more servers to provide the services to the device user. These devices include a computer processor for running the service programs, a telecommunications port (TCP) for connecting to the Internet, and volatile or non-volatile computer memory for the temporary or long-term storage of information.

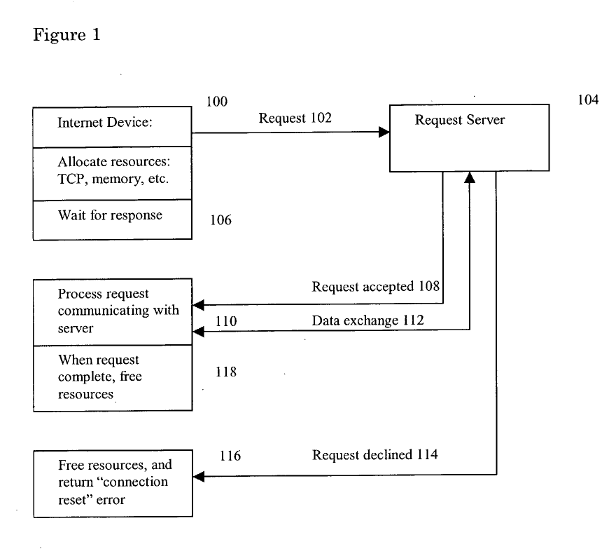

Referring now to FIG. 1. This illustrates the connection sequence of a current art Internet device. The device 100 makes a service connect request 102 to an appropriate server 104 by allocating and using resources of the device (a TCP, memory, etc.) to store the details of the request for subsequent processing. The device then waits 106 for a reply from the server. If the reply accepts the connection 108, the device continues 110 with the processing of the user operation by exchanging data with the server 112. If the reply declines the connection 114, the resources used by the connection request are freed 116 and available to other requests, and the requesting process is notified of the connection failure. The steps of FIG. 1 are repeated for each request, including simultaneous and overlapping requests. That is, in the time while the device is waiting for a reply 106, zero or more requests to the same or other server may be made in response to user operation requests. In this process, if there are insufficient resources to save the request details at 102, the connection fails, and processing continues at step 114. When the service connection is no longer needed 118, the resources used by the request are freed.

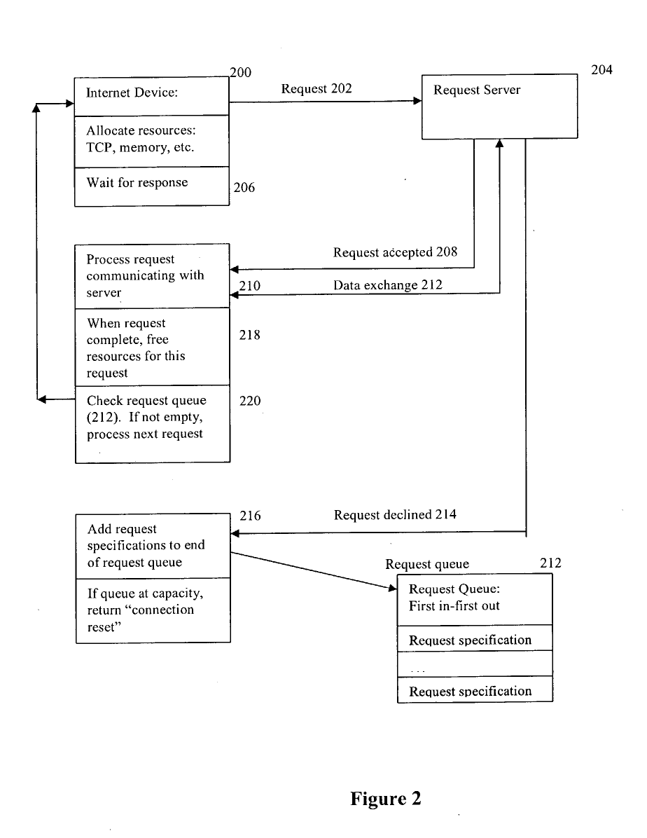

Referring now to FIG. 2. This illustrates the processing of the present invention. Device 200 makes a service request 202 to an appropriate server 204 by allocating a TCP and other resources, e.g. computer memory, and then waits for a connection response from the server 206. If the allocation is successful 208, the processing of the request continues 210 to completion by exchanging data with the server 212. When complete, any remaining resources are freed 218.

If the allocation of resources fails 214, then the request is saved 216 in a “first in-first out” queue 212. If the queue is at capacity 218, a connection reset is sent to the requestor 220. Continuing now from step 210, when a service request is completed, and the queue 212 is not empty, then the oldest (first in) request is retrieved 214, and processed as from step 204. If the queue 212 is empty, then processing ends 216 until a new service request starts the process at 200.

The queue 212 is a linked list that contains structures for connection request information. The buffered information will include the following information:

Received TCP segment information (i.e. the segment that actively requested that the connection be opened identifiable by a unique tag or flag). This will include sequence numbers, port information, foreign maximum receive information, etc.

Received IP datagram information such as source IP address and IP precedence.

Other information required to later retrieve the request and process.

When a TCP request for a provided server service is received, but there are insufficient resources, for example, no server TCP's currently available, the received request is added to the linked list. When a request successful completes, the linked list is examined for any request that can be started with the resources available from the completed request. If so, then the oldest pending request which can now be processed is removed from the linked list and the saved request information is passed to the TCP for processing. If the linked list is empty or no pending segments match the service being offered by the now available TCP, then this TCP becomes available for a future request as per conventional TCP operation.

The application program may cancel a request before it completes. For example, if the user ends the application program which has made a request, then the processing depends on whether the request was processed or queued. If the request was processed, then normal protocol cancellation is done, in which the server is notified of a “connection reset” and resources used by the request are made available. Referring to FIG. 2, processing continues at step 210. If the request is not processed but queued, the saved request information in queue 212 is located and dequeued.

### CONCLUSION

This method allows resource limited devices to make service requests to one or more simultaneous servers while minimizing the number of requests which fail due to unavailable resources.

What is claimed is:

1. A method, executed in software, for establishing an Internet connection between a device and a server, comprising the steps of:
allocating a telecommunications port of the device and making a service request to a server from that telecommunications port;
using the device to establish a failed request queue and queuing the request, if it was unsuccessful;
reverting to the queue if the queue is not empty;
retrieving the oldest request from the queue and attempting a service request based on the oldest request.

2. The method of claim 1, wherein:
the queue is a linked list that contains structures for connection request information.

3. The method of claim 2, wherein:
the structures comprise received TCP segment information.

4. The method of claim 2, wherein:
the structures comprise received IP datagram information.

5. The method of claim 1, further comprising the step of:
examining, after a successful request has been completed, the linked list is examined for any request that can be started with the resources free from the completed request.

6. The method of claim 5, further comprising the steps of:
identifying two or more eligible requests that can be started with the resources free from the completed request; then
selecting from eligible requests that can be started, the oldest one and processing it.

7. The method of claim 1, wherein:
a queued request is cancelled before it is completed.

8. Software for establishing an Internet connection between a device and a server, comprising modules for:
allocating a telecommunications port of the device and making a service request to a server from that telecommunications port;
using the device to establish a failed request queue and queuing the request, if it was unsuccessful;
reverting to the queue if the queue is not empty;
retrieving the oldest request from the queue and attempting a service request based on the oldest request.

9. The method of claim 8, wherein:
the queue is a linked list that contains structures for connection request information.

10. The method of claim 9, wherein:
the structures comprise received TCP segment information.

11. The method of claim 9, wherein:
the structures comprise received IP datagram information.

12. The method of claim 8, further comprising the step of:
examining, after a successful request has been completed, the linked list is examined for any request that can be started with the resources free from the completed request.

13. The method of claim 12, further comprising the steps of:
identifying two or more eligible requests that can be started with the resources free from the completed request; then
selecting from eligible requests that can be started, the oldest one and processing it.

14. The method of claim 8, wherein:
a queued request is cancelled before it is completed.

15. A hardware device when running the software of claim 8.
